(19) United States
(12) Patent Application Publication
(10) Pub. No.: US 2004/0130631 A1
(43) Pub. Date: Jul. 8, 2004

(54) Method of improving image of human face in digital camera

(75) Inventor: Inh-seok Suh, Suwon-si (KR)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/683,318

(22) Filed: Oct. 10, 2003

(30) Foreign Application Priority Data
Oct. 10, 2002 (KR) 2002-61791

(51) Int. Cl. H04N 5/228

(52) U.S. Cl. 348/222.1

(57) ABSTRACT

Provided is a method of improving an image of a face in a digital camera including an image photographing unit, an image signal processing unit, a data storing unit, a recording medium, a operation unit, a display unit, and a control unit. The image improving method is performed with respect to a block of interest in an image divided into unit blocks of a predetermined size. The method is performed by determining whether there is an instruction to perform a whitening function, marking an area having a predetermined size as a marked block, classifying a face area having the same characteristic as the marked block, and improving the image of a face by detecting and removing spots in the area having the same characteristic as the marked block.

### BACKGROUND OF THE INVENTION

This application claims the priority of Korean Patent Application No. 2002-61791 filed on 10 Oct. 2002 in the Korean Intellectual Property Office, the disclosure of which is incorporated herein in its entirety by reference.

1. Field of the Invention

The present invention relates to a digital camera, and more particularly, to a method of improving an image of a human face in a digital camera using a whitening function when an image including a human face is photographed or played.

2. Description of the Related Art

A digital camera uses a CCD or MOS type image sensor as an image sensor. These sensors detect light differently than human eyes do, and small, vague marks or blemishes are often overly emphasized in a photograph. Also, a digital camera may noticeably emphasize a minor difference in the color of skin of a person in a photograph. Digital camera users often want to de-emphasize or eliminate blemishes and marks from photos. However, conventional digital cameras have not completely satisfied such a need. Currently, users typically ask image-editing experts to correct the photos or directly edit the photos using home computer software utilities and applications.

### SUMMARY OF THE INVENTION

In order to solve the above and/or other problems, the present invention provides a method of improving a human face in a digital camera by removing spots such as blemishes or marks included in an image of a person and correcting brightness and color of the face according to the instructions by a user.

According to an aspect of the present invention, a method of improving an image of a face in a digital camera, the method comprising the steps of determining whether there is an instruction to perform a whitening function, marking an area having a predetermined size to which the whitening function is performed by a user in the image displayed on the display unit as a marked block, classifying a face area having the same characteristic as the marked block, and improving the image of a face by detecting and removing a spot in the area having the same characteristic as the marked block.

The method further comprises an optional step of performing a post-process with respect to the image location where the spot is removed according to a predetermined reference value.

The method further comprises an optional step of correcting the brightness and color of the face according to instructions by the user with respect to the image where the spot is removed.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram for explaining the structure of a digital camera according to a preferred embodiment of the present invention;

FIG. 2 is a view illustrating an example of a surface of a camera including an operation unit and a display unit shown in FIG. 1;

FIG. 3 is a flow chart for explaining a method of improving a human face in a digital camera according to a preferred embodiment of the present invention;

FIG. 4 is a flow chart for explaining Step S30 shown in FIG. 3 according to a preferred embodiment of the present invention;

FIG. 5 is a flow chart for explaining Step S40 shown in FIG. 3 according to a preferred embodiment of the present invention;

FIG. 6 is a view for explaining a method of replacing a spot block by an average value of neighboring blocks, as one of methods of removing a spot;

FIG. 7 is a flow chart for explaining Step S50 of FIG. 3 according to a preferred embodiment of the present invention; and

FIG. 8 is a flow chart for explaining Step S60 shown in FIG. 3 according to a preferred embodiment of the present invention.

### DETAILED DESCRIPTION OF THE INVENTION

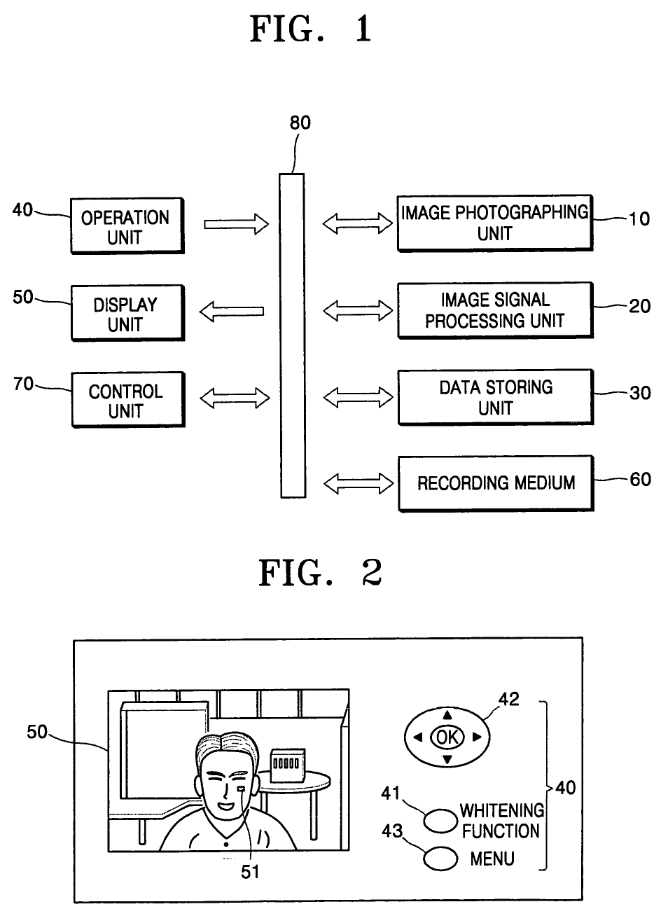

Referring to FIG. 1, a digital camera performing a method of improving a human face according to the present invention includes an image photographing unit 10, an image processing unit 20, a data storing unit 30, a operation unit 40, a display unit 50, a control unit 70, and a recording medium 60. The respective units transmit and receive signals via a data bus 80.

The image photographing unit 10 photographs an image of an object. The image photographing unit 10 includes an image photographing lens group, an actuating mechanism and a driving circuit for the image photographing lens group, and a solid state imaging device such as a CCD or MOS type image sensor. The solid state imaging device, which is formed of arrays of electrical cells, receives light reflected from an object as analog image data, while outputting digital image data having a particular resolution. The smallest unit of output data, which corresponds to each cell of the sensor, is referred to as a pixel.

The image signal processing unit 20 is a digital signal processor (DSP). The image signal processing unit 20 performs digital image processing on the photographed image input from the image photographing unit 10 and outputs a processed image.

The data storing unit 30 includes a temporary data storing unit and a non-volatile storing unit. The temporary data storing unit stores the digital image data received from the image signal processing unit 20. The non-volatile storing unit may store control algorithms for the digital camera settings and driving the control unit 70.

The recording medium 60 may be a form of portable storage media, such as a Compact Flash card, a SmartMedia card, and a Memory Stick, which may be inserted into a recording medium interface provided in the digital camera. Alternatively, the recording medium 60 may be fixed.

The controller 70 controls the operation unit 40, the display unit 50, and the recording medium 60 to perform the method of improving an image of a face according to the present invention with respect to the image photographed by the image photographing unit 10 and processed by the image signal processing unit 20 or the image reproduced from the recording medium 60.

The operation unit 40 includes various function selection keys and direction keys for selecting an area. When a user operates the keys, the operation unit 40 generates and outputs key data.

The display unit 50 displays the image photographed by the image photographing unit 10 and processed by the image signal processing unit 20 or the image reproduced from the recording medium 60.

FIG. 2 is a view showing the operation unit 40 and the display unit 50. Referring to FIG. 2, the operation unit 40 may include a direction key 42 having up, down, left, and right keys and a selection (OK) key. The operation unit 40 may include a menu key 43 to select functions of the digital camera. The display unit 50 displays a marked block cursor 51 (the marked block is described further below) when a user selects the whitening function selection key 41. The marked block cursor 51 may move up, down, left, and right corresponding to the operation of the direction key 42.

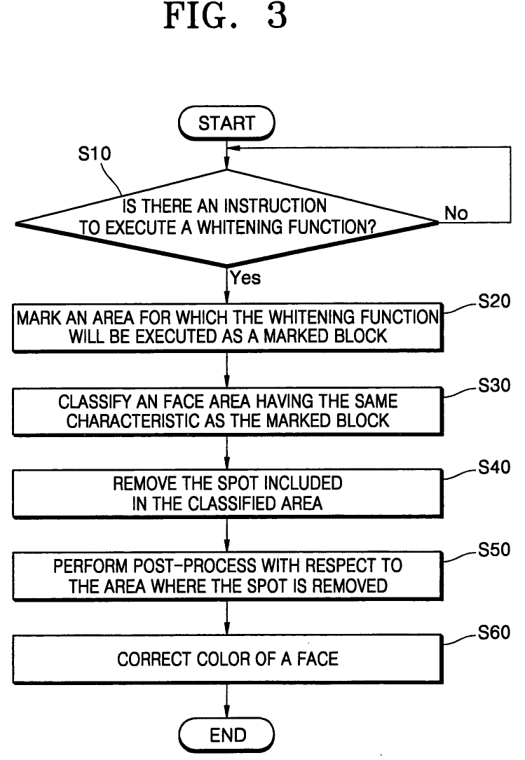

FIG. 3 is a flow chart for explaining a method for improving the image of a face in a digital photograph according to a preferred embodiment of the present invention. The method includes steps S10-S40 to remove spots by detecting the spots in an area of a face in an image having the same characteristic as a block marked by a user in a display unit 50. The method may include a step S50 in which an image where the spots are removed goes under a post-process and a step S60 in which the color of a face is corrected.

In detail, in step S10, it is determined whether there is an instruction to execute the whitening function (which may be otherwise labeled via any appropriate nomenclature). For example, the instruction to execute the whitening function is input when a user engages the operation unit 40 shown in FIGS. 1 and 2, specifically by pressing the whitening function selection key 41 of FIG. 2.

In step S20, the user marks a block of a predetermined size in which the whitening function will be executed. The size of the marked block is determined based upon the size of the spot to be removed. The size of the marked block is set to be greater than the expected maximum size of a spot. The size of the marked block is set so that the average brightness and color values of the marked block are relatively close to that of the overall face image area. If the size of the marked block is too small and the marked block includes a spot, the average brightness value of the marked block may be too low and outside an acceptable range for the face image area. In such a case, an error is deemed to have occurred in determining the image area having the same characteristic as the marked block in step S30 to be described later. The size of the marked block is determined according to the size of a resolution of a digital camera and the size of a marked block cursor. For example, the size of the marked block may be 64×64 pixels. The user may input a marked block to designate a spot removing area by using the direction key 42 of FIG. 2. The direction key 42 preferably includes an up arrow key, a down arrow key, a left arrow key, a right arrow key, and a selection key (OK).

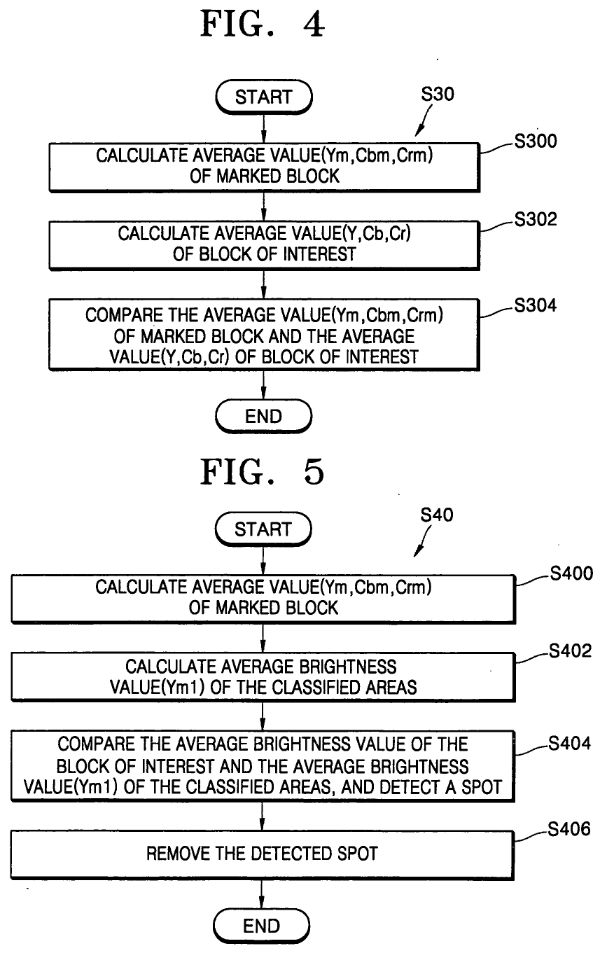

In step S30, an image area having the same characteristic as the marked block in the display is classified as a face area to be improved. FIG. 4 is a flow chart that explains step S30 of FIG. 3 in detail, according to a preferred embodiment of the present invention. In step S30, pixel values within a predetermined allowance range with respect to average value Ym, Cbm, Crm of the marked block are processed as an area having the same characteristic as the marked block. Step S30 includes the sub-steps of calculating average value Ym, Cbm, Crm of the marked block (S300), calculating average value Y, Cb, Cr of the block of interest (S302), and comparing the average value Ym, Cbm, Crm of the marked block and the average value Y, Cb, Cr of the block of interest (S304). The term “average value” denotes an average pixel value of a block including an average brightness value and an average color value.

In detail, in step S300, the average value Ym, Cbm, Crm of the marked block is calculated. The marked block is a block formed of a predetermined number of pixels, for example, 64×64 pixels, in which each pixel has a brightness value and a color value. As an example of representing a pixel value by dividing brightness and color, a YCbCr model has a relationship to an RGB primary color model as shown in Equation 1.

Y=0.29900R+0.58700G+0.11400B

Cb=−0.16874R−0.33126G+0.50000B

Cr=0.50000R−0.41869G−0.08131B [Equation 1]

Here the value Y indicating brightness may be, for example, within 0 through 255 while the value Cb indicating blue information and the value Cr indicating red information may be, for example, within −127 through +127.

An example of calculating the average value Ym, Cbm, Crm of the marked block is shown in Equation 2.

Ym=(Y1+Y2+ . . . +Yn)/n

Cbm=(Cb1+Cb2+ . . . +Cbn)/n

Crm=(Cr1+Cr2+ . . . +Crn)/n [Equation 2]

Here, n may be 64×64 that is the size of the marked block.

In step S302, the average value Y, Cb, Cr of the “block of interest” is calculated. The “block of interest” is a unit block including a predetermined number of pixels in horizontal and vertical dimensions in which the method of improving an image of a face according to the present invention is performed. Here, the size of a unit block is determined considering image resolution, processing speed, and memory capacity. For example, each unit block may have a size of 16×16 pixels. According to the method of the present invention, in an image in which a face area is intermingled with other types of areas, it must be determined whether a particular block of interest belongs to the face area or not. Then, spots are continuously and sequentially removed in the same manner by using a neighboring block as the new block of interest. The average value of the block of interest can be calculated by applying the size of a unit block, for example, n=16×16, to Equation 2.

In step S304, the calculated average value Y, Cb, Cr of the block of interest is compared with the calculated average value Ym, Cbm, Crm of the marked block to determine whether to perform a spot removing process with respect to the block of interest. An example of the method of comparing the average value of the block of interest and the average value of the marked block is shown below in Equation 3.

Ym−α<Y<Ym+α

Cbm−β<Cb<Cbm+β

Crm−γ<Cr<Crm+γ [Equation 3]

Here, the values Y, Cb, Cr are the average value of the block of interest. α, β, and γ are predetermined errors for indicating the spot removing area.

In step S40, a spot that has a different color from a face is removed from the face area. Step S40 does not change the original color of a face, but removes spots with hues different from the face color, such as blemishes or marks that a user does not want.

FIG. 5 is a flow chart that explains step S40 of FIG. 4 in detail, according to a preferred embodiment of the present invention. Step S40 includes sub-steps of calculating the average value (Ym, Cbm, Crm) of the marked block (S400), calculating the average brightness value (Ym1) of the classified areas (S402), detecting a spot (S404), and removing the detected spot (S406).

Step S400—calculating the average value (Ym, Cbm, Crm) of the marked block—is the same as step S300. In step S402, the average brightness value (Ym1) of the face areas where spots are to be removed is calculated. In step S404, a block including an image recognized as a spot is detected from the classified face areas. In step S404, it is determined whether Equation 4 is satisfied with respect to the average brightness value Y of the unit blocks, the average brightness value Ym1 of the face area, and a predetermined value K.

Y<Ym1−K [Equation 4]

A unit block satisfying Equation 4 is an area including a spot to be removed. That is, a block that is darker than average by a predetermined level of brightness is recognized as a block including a spot. The method can easily be adapted to remove bright spots by changing the minus to a plus and changing the less-than sign to a greater-than sign.

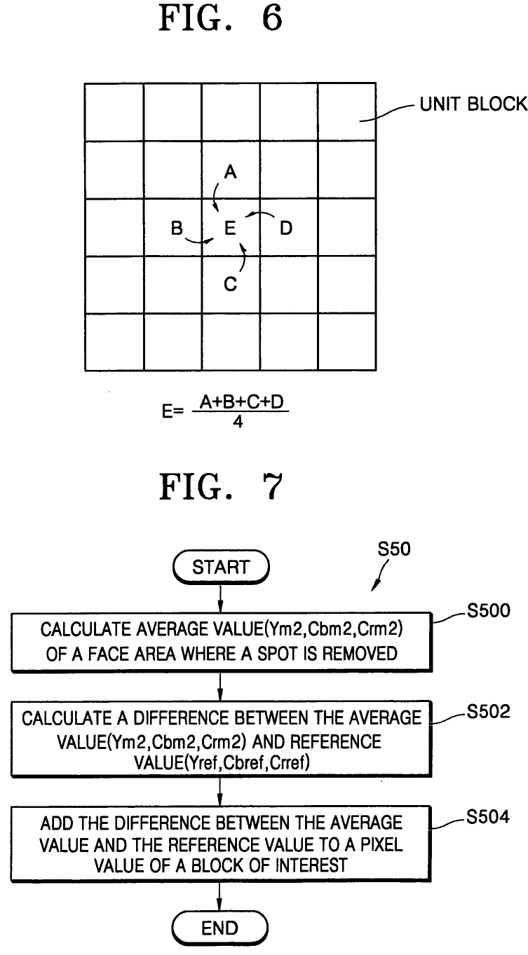

In step S406, the spot detected in step S404 is removed. When it is determined that Equation 4 is satisfied, the spot is removed by substituting a block pixel value with the average brightness value and the average color value of neighboring unit blocks. FIG. 6 is a view showing a method of removing a spot by using neighboring blocks of the block where the spot is detected according to a preferred embodiment of the present invention. In FIG. 6, each block denotes a unit block, for example, a 16×16 pixel unit block, and a block E is a block including a spot. A block pixel value of the spot block E is substituted with an average value of the block pixel values of the neighboring unit blocks A, B, C, and D.

Referring back to FIG. 3, step S50 is selectively included to perform a post-process to an image where a spot is removed. FIG. 7 is a flow chart for explaining step S50 according to a preferred embodiment of the present invention. Step S50 includes sub-steps of calculating an average (S500), calculating a difference between an average value and a reference value (S502), and adding the calculated difference to a unit block (S504). The term “reference value” denotes a reference pixel value of a block including a reference brightness value and a reference color value.

In step S500, the average value (Ym2, Crm2, Cbm2) of the face area where a spot is removed is calculated.

In step S502, the difference (YΔ, CbΔ, CrΔ) between a reference value (Yref, Cbref, Crref) of a preset whitening function and the average value (Ym2, Crm2, Cbm2) calculated in step S500 is calculated. The difference (YΔ, CbΔ, CrΔ) can be set by a manufacturer when a digital camera is manufactured.

In step S504, the difference (YΔ, CbΔ, CrΔ) between the average and the reference value is added to a pixel value of the block of interest.

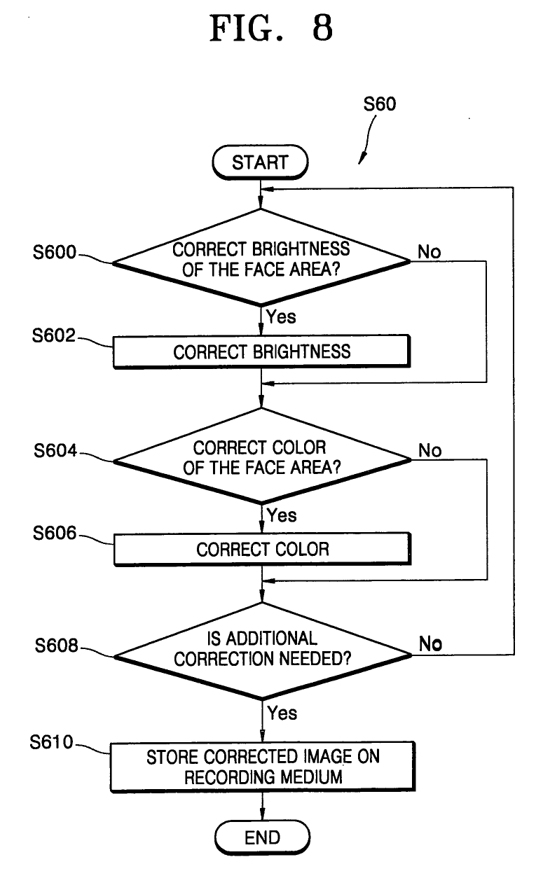

Referring back to FIG. 3, in step S60, the color of a face is corrected according to the instruction by a user. Step S60 is optionally included in the present invention. FIG. 8 is a flow chart for explaining step S60 of FIG. 3 according to a preferred embodiment of the present invention. Step S60 includes sub-steps of determining whether to correct brightness (S600), correcting brightness (S602), determining whether to correct color (S604), correcting color (S606), determining whether an additional correction is needed (S608), and storing a corrected image on a recording medium (S610).

In step S600, whether to correct the brightness of a face is determined. In step S600, the image after a spot is removed in step S40 or the image that is post-processed in optional step S50 is displayed on the display unit 50. A message asks the user whether he/she wants to perform brightness correction, for example, “Would you like to correct brightness? Yes No”. If the user answers yes (in this case by setting the cursor (which may default to “Yes”) to “Yes” and pressing the selection key (OK)), the program proceeds to step S602 in which the brightness of the face is corrected. If the user moves the cursor to “No” by using the direction key 42 and pressing the selection key (OK), the program proceeds to step S604.

In step S602, brightness is corrected according to instructions of the user. A scale showing levels of brightness is displayed on the display unit 50. A cursor indicating the level of brightness is initially located at the center level and may be moved by the user via the direction key 42. The control unit 70 enables the change in brightness level to be apparent on the display unit 50. After changing the brightness of an image of a face displayed on the display unit 50 by using the direction key 42, the user selects the desired brightness by using the selection key (OK).

In step S604, whether to correct the color of the face area is determined. The resultant image of the previous step is displayed on the display unit 50. A message asking the user whether he/she has an intention to correct the color of the face, for example, “Would you like to correct color? Yes No”, is displayed. If, for example, a default cursor is set to “Yes” and the user presses the selection key (OK), the program proceeds to step S606 in which the color of a face is corrected. If the user moves the cursor to “No” by using the direction key 42 and presses the selection key (OK), the program proceeds to step S608.

In step S606, the color of the face is corrected according to instructions by the user. In a preferred embodiment, the color is divided into red-based color and white-based color and the display unit 50 shows a scale of the color level. A cursor indicating the level of color is initially located at the center of the scale and may be moved by the user via the direction key 42. The control unit 70 enables the shift in the color level towards being redder or whiter to be apparent on the display unit 50. After changing the color of the face image on the display unit 50 by using the direction key 42, the user selects a desired color by using the selection key (OK).

In step S608, whether an additional correction is needed is determined. If it is determined that an additional correction is needed, the program proceeds to step S600 to correct brightness and color. To execute step S608, the image where the changes corrected in step S606 are reflected is displayed on the display unit 50 a message asking the user whether he/she has an intention to correct additionally, for example, “Would like you to store an image as displayed? Yes No”. If the user set a default cursor to “Yes” and presses the selection key (OK), the program proceeds to step S610. If the user moves the cursor to “No” by using the direction key 42 and presses the selection key (OK), the program proceeds to step S600 so that additional correction of brightness and color can be performed. Lastly, in step S610, an improved image is stored on the recording medium 60 shown in FIG. 1.

In the present invention, an image reflecting the process performed in the previous step can be displayed on the display unit 50 between the respective steps.

As described above, according to the method of improving an image of a face in a digital camera according to the present invention, spots such as blemishes and marks included in an image of a human face can be removed and the brightness and color of the face image can be corrected according to the instruction by the user.

While this invention has been particularly shown and described with reference to preferred embodiments thereof, it will be understood by those skilled in the art that various changes in form and details may be made therein without departing from the spirit and scope of the invention as defined by the appended claims. In particular, certain items that may be predetermined in the preferred embodiments described above, might also be determined by the user.

What is claimed is:

1. A method for improving an image of a face in a digital camera, the method comprising the steps of:
(a) determining whether there is an instruction to perform a whitening function;
(b) marking an area block in the image displayed on the display unit;
(c) classifying a face area having the same characteristic as the marked block; and
(d) detecting and removing at least one spot in the face area.

2. The method of claim 1, wherein the size of the marked area is predetermined.

3. The method of claim 1, wherein the marked block has a rectangular shape.

4. The method of claim 1, wherein step (c) further comprises the steps of:
(c1) calculating an average value of the marked block;
(c2) calculating an average value of at least one block of interest; and
(c3) comparing the average value of at least one block of interest and the average value of the marked block.

5. The method of claim 4, wherein the average value comprises at least one brightness component and at least one color component.

6. The method of claim 5, wherein the average value comprises one brightness component and two color components.

7. The method of claim 1, wherein step (d) further comprises the steps of:
(d1) calculating an average value of the marked block;
(d2) calculating an average value of brightness of at least one block of interest;
(d3) comparing the average value of brightness of the at least one block of interest and the average value of brightness of the marked block;
(d4) determining whether a spot exists; and
(d5) removing the detected spot.

8. The method of claim 7, wherein step (d4) further comprises the step of:
if the average brightness value of the at least one block of interest is less than the average brightness value of the marked block by a certain amount, determine that a spot does exist in the block of interest.

9. The method of claim 7, wherein step (d5) further comprises the steps of:
(d5.1) determining the average value of at least one unit block adjacent to the at least one block of interest; and
(d5.2) replacing the at least one block of interest with a unit block having the average value of the adjacent unit blocks.

10. The method of claim 1, further comprising the step of:
(e) performing a post-process with respect to at least one image location where a spot is removed.

11. The method as claimed in claim 10, wherein step (e) further comprises:
(e1) calculating an average value of at least one face area location in which a spot is removed;
(e2) calculating a difference between the calculated average value of the at least one face area location in which a spot is removed, and a predetermined reference value; and
(e3) adding the difference between the calculated average value of the at least one face area location, and the reference value, to a pixel value of the block of interest.

12. The method of claim 1, further comprising:
(f) correcting color of the face with respect to the image location where the spot is removed.

13. The method as claimed in claim 12, wherein step (f) further comprises:
(f1) determining whether brightness correction function is selected;
(f2) if brightness correction function is selected, correcting the brightness of the face area;
(f3) determining whether color correction function is selected;
(f4) if color correction function is selected, correcting the color of the face area;
(f5) determining whether additional correction is selected;
(f6) if additional correction is selected, proceeding to step (f1); and
(f6) if additional correction is not selected, storing the corrected image on a recording medium.

14. The method of claim 13, wherein step (f2) further comprises:
(f2.1) displaying a scale showing levels of brightness; and
(f2.2) allowing a user to select at least one of the levels of brightness.

15. The method of claim 13, wherein step (f4) further comprises:
(f4.1) displaying a scale showing levels of color; and
(f4.2) allowing a user to select at least one level of color.

16. The method of claim 15, wherein the scale measures the level or red-based color and white-based color.
